(19) United States
(12) Patent Application Publication
(10) Pub. No.: US 2014/0201625 A1
(43) Pub. Date: Jul. 17, 2014

(54) SYSTEM AND METHOD FOR GENERATING A BROWSER COMPATIBLE DOCUMENT

(71) Applicant: Concepts in Data Management, SRL, St. Michael (BB)

(72) Inventor: Martin Scrocchi, London (CA)

(73) Assignee: Concepts in Data Management, SRL, St. Michael (BB)

(21) Appl. No.: 14/210,950

(22) Filed: Mar. 14, 2014

Related U.S. Application Data
(63) Continuation-in-part of application No. 13/454,930, filed on Apr. 24, 2012.
(60) Provisional application No. 61/802,249, filed on Mar. 15, 2013.

(51) Int. Cl. G06F 17/24; H04L 29/08

(52) U.S. Cl. CPC G06F 17/24; H04L 67/02
USPC 715/255

(57) ABSTRACT

Systems and methods for converting a document based on document request and browser-type user interface is provided. The system includes a processor based platform having a user interface configured to execute a document request having document identification information, and a requestor ID having identification information corresponding to the user interface. A server computer configured to execute a document request, the server platform being operatively connected to a database, repository, and a document conversion engine, wherein the document conversion engine includes a means for processing a document request. Wherein the means for processing a document request processes the document request based on said document request and said requestor ID, and transmits a version of a document compatible with the user interface, and corresponding to the document identification information.

### CROSS-REFERENCE TO RELATED APPLICATIONS

This application is a continuation-in-part of U.S. patent application Ser. No. 13/454,930, filed Apr. 24, 2012, entitled “SYSTEM AND METHOD FOR GENERATING A BROWSER COMPATIBLE DOCUMENT”. This application also claims priority to U.S. Provisional Application Ser. No. 61/802,249, filed Mar. 15, 2013, entitled “DOCUMENT IDENTIFIER AND METHOD OF USING THE SAME”. The entireties of the aforementioned applications are herein incorporated by reference.

### TECHNICAL FIELD

This application relates generally to information technology and, more particularly, to systems and methods for generating a document capable of being viewed across multiple browsers.

### BACKGROUND OF THE INVENTION

Today, computer systems have progressed to where it is possible for users to access software applications and documents remotely using a number of devices having different features. Examples of such devices include desktop computers (workstations and/or servers), laptops/notebooks, netbooks, ultrabooks, tablets, and other mobile devices (e.g., cellular phones etc.). These devices are provided to users by many different companies (e.g., Apple®, Samsung®, Microsoft®), some using similar operating systems as an interface for the device, some using very different operating systems, which force third party developers to develop various versions of applications based on the operating system. For example, Apple® products tend to run some form of iOS operating system, which cannot execute executable files developed and compiled for a Windows® operating systems. One example of this file type is the .exe file type. This lack of cross-operating compatibility forces developers who initially compile their applications into a .exe format, to recompile their application into a .dmg format, so that the iOS operating system can execute the application. This problem is not only particular to applications, but documents are also experiencing cross-operating system compatibility issues. Particularly, when users on different operating platforms, use proprietary web browsers for accessing specific documents. For example, versions of the Safari® browser, which is an Apple® product used with its iOS operating system, fail to properly display portable document format (PDF) documents. Creating multiple versions of a PDF document to accommodate a particular browser is not always practical. For example, in the real estate industry, due to the volume of documents stored as PDF files, the process of duplicating files is burdensome.

Moreover, because of the increasing number of users accessing documents remotely using such mobile devices, it has become difficult to track the document requests and which users are requesting the documents. Additionally, with the increased number of users accessing specific documents, it is also difficult to restrict the type of information each user is authorized to access in the requested document.

### BRIEF SUMMARY OF THE INVENTION

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

An embodiment of the present invention comprises a non-transitory computer-readable medium having computer-executable instructions recorded thereon and capable of being executed by a processing element of a computer processing platform. The computer-executable instructions include instructions for receiving a document transmission request for a document to be displayed to a requestor. The document transmission request includes a document ID to identify the document to be transmitted. The computer-executable instructions further include instructions for processing requestor information for identifying the requestor's browser-type. The computer-executable instructions also include instructions for processing the document transmission request based on the document ID and the browser-type, and queuing a version of a document corresponding to the document transmission request and compatible with the browser-type. Additionally, the computer-executable instructions include instructions for transmitting the version of a document to the requestor, and displaying the version of a document.

In yet a further embodiment of the present invention, a method for generating a browser compatible document is provided. The method includes the steps of receiving a document request from a processor based platform having a user interface, and the document request having document identification information. The method also includes the steps of receiving a requestor information notice from the processor based platform, the requestor information notice having processor based platform information. The method further includes the steps of processing the document request via a document conversion engine, the document conversion engine being operatively connected to the processor based platform. The document conversion engine processes the document request based on at least one of the document identification information and the processor based platform information to produce a version of a document being compatible and displayable with the user interface. The method also includes the steps of transmitting the produced version of a document to the processor based platform, and displaying the version of a document via the user interface.

In yet a further embodiment of the present invention a document conversion system based on a requestor's document request and browser-type is provided. The document conversion system includes a processor based platform having a user interface configured to submit a document request having document information and a requestor ID having identification information corresponding to the user interface. The document conversion system also includes a server computer configured to execute a document request. The server computer is operatively connected to a document conversion engine configured to process a document request based on the document information and the identification information, and configured to produce a version of a document compatible for viewing with the user interface.

These and other embodiments are described in more detail below.

### BRIEF DESCRIPTION OF THE DRAWING

Various non-limiting embodiments are further described with reference the accompanying drawings in which:

FIG. 1 is a schematic diagram of a system according to one or more aspects;

FIG. 2 is a functional block diagram of a document conversion server according to an embodiment;

FIG. 3 is a functional block diagram of a document conversion engine hosted on the document conversion server of FIG. 2 according to one or more aspects;

FIG. 4 is a flowchart of a method of generating a browser compatible document based on a compatibility database listing hosted on the document conversion server in accordance with one or more aspects;

FIG. 5 is a flowchart of a method of generating a browser compatible document based on an incompatibility database listing hosted on the document conversion server in accordance with one or more aspects;

FIG. 6 is a flowchart of a method of converting a browser compatible document based on a display confirmation according to one or more aspects; and

FIG. 7 is a flowchart of a method of generating and applying a document identifier according to one or more aspects.

### DETAILED DESCRIPTION OF THE INVENTION

The term “computer processing platform”, as used herein, means a hardware platform having at least one processor that is programmed to execute software instructions. The term “server”, as used herein, generically refers to a combination of hardware and software configured to serve the needs or requests of other programs (i.e., clients) which may or may not be running on the same computer hardware. The term “module”, as used herein, refers to a small self-contained program of computer-executable instructions that performs a defined function or functions and may operate within a larger program suite of other modules. The term “queuing” means to select a document which generally occurs prior to transmitting or processing a version of the document.

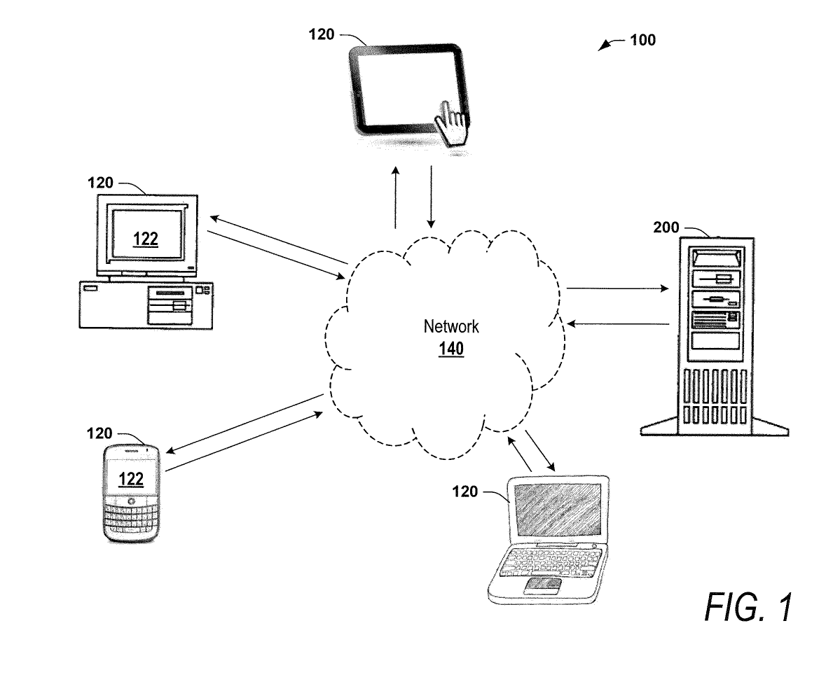

FIG. 1 illustrates a logical view a system 100 for receiving a document request, processing the document request based on browser identification information transmitted with the document request, and transmitting and displaying a browser compatible document to the requesting browser within the system 100. The system 100 includes various components operationally connected to a network 140. For example, the system 100 includes a user interface or a web browser 122 hosted on a user device 120, which is used by a user to navigate through the system 100 via the network 140. The system 100 also includes a document conversion server (DCS) 200 operationally connected to the user device 120 via the network 140 for processing document requests from the user device 120. The system 100 also includes a plurality of documents (not shown) which may be accessed by the user via the network 140 by request. The network 140 may be a wired or wireless local area network (LAN), a wide area network (WAN) (e.g., internet), a cellular network, (e.g., 3G/4G technology) or other infrastructure or system transmitting information known to a person of ordinary skill in the art.

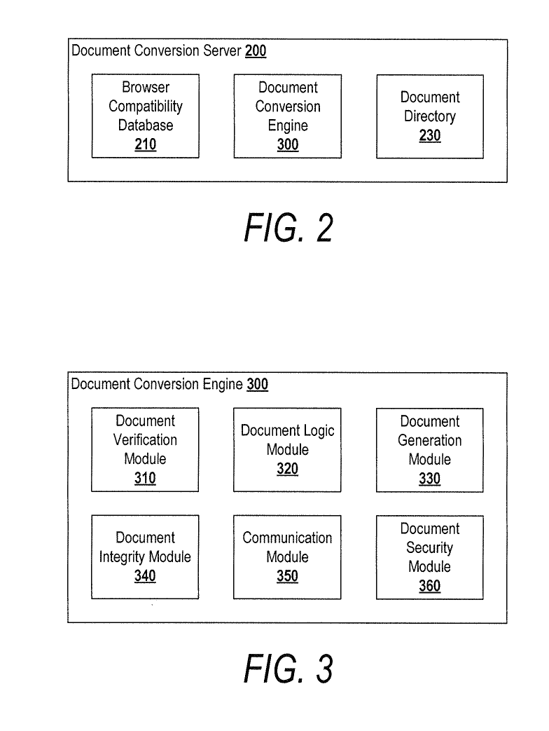

In accordance with an embodiment of the present invention, the DCS 200 may be accessed by the user device 120 via the network 140 to facilitate processing and transmitting the user's document request. The transmission of the documents may be dependent upon information gathered from the user device 120, i.e., requestor information. The web browser information may be gathered from a browser request header, notice, meta data, or other suitable means for identifying the user's browser-type known to persons of ordinary skill in the art. For example, some browser request headers provide information on the web browser type, version, location of the user device, as well as browser developer information. Any one of these pieces of information may be used by the DCS 200 to process the user's document request. FIG. 2 illustrates an exemplary embodiment of the document conversion server (DCS) 200 of the system 100 FIG. 1. The DCS 200 may be a single server, or a plurality of servers working in concert to accomplish the tasks for the DCS 200 described herein. Additionally, The DCS 200 may also be one or more interconnected pieces of hardware, e.g., cluster, web farm, sequential computing, blade etc. The DCS 200 includes at least one database 210 operationally connected to a document conversion engine/application (DCE) 300 which may be a series of codes capable of converting documents, or codes compiled into a software application, both configured to run on the hardware of the DCS 200. The database 210 may include a listing of compatible or incompatible browsers based on browser identification information common to most browsers. The DCS 200 also includes a document directory 230 operationally connected to the DCS 200. The document directory 230 serves as a repository for documents and may include any number of documents in their original format, converted format or both. The document directory 230 may be external to the DCS 200 or hosted within the DCS 200. For example, external document directories 230 may be located on an external hard disk drive, or a cloud server accessible via the network 140. Document directories 230 hosted within the DCS 200 may be found within a secured or unsecured folder on an internal hard disk drive, or within a database table designated to store documents of any type. In yet a further embodiment of DCS 200, multiple databases 210 and document directories 230 may be hosted or operationally connected to the DCS 200, for accommodating voluminous requests by users.

FIG. 3 illustrates an exemplary embodiment of the document conversion engine/application (DCE) 300 hosted on the document conversion server of FIG. 2. The DCE 300 is made up of a means for processing a document request, i.e., one or more modules that may include a document verification (DV) module 310, a document logic (DL) module 320, a document generation (DG) module 330, a document integrity (DI) module 340, a communication interface (COMM) module 350, and a document security (DS) module 360. The modules 310-360 may be organized and reconfigured (e.g., combined or split-up) into other modules, in accordance with other various embodiments of the present invention, while preserving the overall functionality of the DCE 300 or the DCS 200. Additionally, the modules 310-360 may reside on separate hardware components, for example, the COMM module 350 may reside on a network interface card (NIC) operatively connected to the DCE 300 to perform the necessary functions, which will be discussed in further detail below. In a further embodiment, the DCE 300 may include hardware components to complete the above modular functions, or a combination of both hardware and modules. In accordance with an embodiment of the present invention, the computer-executable instructions of the modules 310-360 may also be stored on a computer-readable medium such as, for example, a magnetic disk, an optical disk, tape, RAM, ROM, CD-ROM, DVD, or any other type of removable or non-removable medium which can be used to store the DCE 300 or DCS 200.

The document verification (DV) module 310 may function as the means for verifying the requested document type (e.g., PDF, DOC), and cross-referencing the displaying capability of the document type with any identified browser types. For example, when a user requests a PDF document using the system 100, the DV module 310 receives the user request to display a PDF document, along with the browser ID, which in this example indicates that the user web browser is a Safari® browser. The browser ID may be transmitted via the browser request header, which is transmitted along with the document request. In addition to including information about the browser type, the request header may include information about the type of device the user is requesting the information from (e.g., mobile device), operating system information, or geographical information related to the user's locale and or specific predetermine user requirements. The DV module 310 may then verify whether the requested document can be displayed properly in the Safari® browser by either cross-referencing the browser information with a listing from the database 210, or via a transmission confirmation that indicates whether or not the transmission has failed or passed. The transmission confirmation may include JavaScript operatively communicating with or embedded in the requested document, and configured to communicate with the DCS 200 identifying whether or not the transmission of a version of the requested document was successful or unsuccessful. Examples of different types of transmissions confirmations may include any number of indicators related to a success message or a failed message. A failed transmission may be determined by a timed out event during the submission of the requested document, or by the DCS 200 not receiving a success confirmation (i.e., no confirmation of any sort is received).

If the browser is not identified in the database 210 as being incompatible, the PDF document is queued, transmitted and displayed to the requestor. However, if the document is identified as being incompatible, the DV module 310 flags the requested document so that it may be converted to a compatible format, such as Hypertext Markup Language 5 (HTML-5), which is compatible with the Safari® browser, or requests to display a previously created compatible document corresponding to the requested document. The DV module 310 also records any information regarding the browser type that was not previously recorded to the database 210 for future reference with regards to the browser type. In a further embodiment of the DV module 310, where the browser is not identified as being incompatible, and is transmitted and displayed to the requestor, if document subsequently communicates with the DCS 200 that the display attempt fails, the DV module 310 receives the failed attempt message, records the browser information as previously indicated, and flags the requested document so that it may be converted into a compatible format. The DV module 310 may also function to verify the requested documents structure, i.e., the layout of the requested document. For example, in one embodiment where the document has three (3) labels, and six (6) fillable fields, the DV module 310 maps the locations of the labels and the fields so that they may be similarly situated in a subsequent version of the document.

The DV module 310 may also function to verify whether or not new or updated information is contained in the fillable fields of a document that has been transmitted by the requestor. Once the DCS 200 concludes that a requested document needs converting, the document logic (DL) module 320 of the DCE 300 begins the conversion process by examining the document properties (DP) of the requested document. The DL module 320 may utilize JavaScript embedded in the incompatible document or JavaScript code configured to identify the DP of the requested document for subsequent use in an updated or newly converted document. The DP may include any number of document properties, including, for example, document logic and field properties, input requirements or restrictions, calculations, and formatting properties (e.g., font style, size etc.). After examining the DP, the DL module 320 transmits the DP to the document generation (DG) module 330, which generates/populates the DP in an updated or new version of the requested document. Updates to a requested document occurs in cases where the requested document is compatible with the requestor's browser type, but the DP has changed and requires updating, and no changes to the document type are required. A new version is a conversion of the requested document, which includes the DP of the original/requested document. This new document is compatible with the requestor's browser type, while maintaining the DP of the original/requested document. The DG module 330 renders the page(s) of the requested document, renders an HTML for each page, extracts the DP from the input fields from the requested document, and creates a compatible DP through JavaScript. The generated page (e.g., HTML-4 or HTML-5 page) includes input fields similar to the requested document. These input fields are tied to the data sources in a similar manner to the requested documents. In a further embodiment, the data source for the generated document and the requested document is the same data source.

In yet a further embodiment, once the DP of the requested document has been determined, either by examination or other means, the DP may be recorded in a database as it relates to the requested document, so that extraction/examination of the requested document, if it is requested at a later time, is not necessary now that the DP is available. Now any subsequent requests for the requested document, may trigger generating the compatible document based on the recorded DP.

In addition to the rendering functionality, and extracting and creating similar characteristics to the requested document, the DG module 330 may alter the characteristics of the requested document. For example, if a font is not supported by a browser, or undesirable, the DG module 330 may change the font to a compatible font, or more favorable font in the converted/generated document. Additionally, other characteristics/features of the document may be altered. For example, the background or watermark of the requested document may be altered, or features that were not present in the requested document, may be added, or features may be removed via the DG module 330.

In addition to the DG module 330 being configured to generate a browser compatible document, the DG module 330 may also receive requests from a user to convert a compatible document, such requests and the benefits are discussed further herein. Optionally, subsequent to the DG module 330 updating or converting a document, the document integrity (DI) module 340 may function to perform an integrity check of the generated document to assure that the DP are in the converted document, that the mapping with structural elements is correct, and that the structural elements are similarly situated as in the original document. The DI module 340 may also function to verify that the compatible document and the original requested document look similar so that a user cannot discern between the versions.

The communication interface (COMM) module 350 functions to facilitate communication between the DCE 300, the DCS 200 and the system 100, via the network 140. In one embodiment, for example, the COMM module 350 may provide a user interface to the user's web browser, to facilitate the user interaction with the DCS 200 or DCE 300. In this embodiment, it is possible that user initiated conversions of documents may be executed using executable commands or links provided within the interface. The COMM module 350 may also function to facilitate communication between the various other modules 310-340 within the DCE 300, or various database 210, document directories 230, or other components within the DCS 200.

The document security (DS) module 360 functions to provide security to and within the requested documents (original, modified or converted) so that unauthorized access or modifications to the document are restricted, and may be based on a number of predetermined rules. Additionally, the DS module 360 may function to manage the document encryption services for the requested documents, thereby providing additional content security for the documents. Additionally, the DS module 360 may certify a document, e.g., provide a digital signature such that any access or modifications to the document may be recorded. Additionally, the DS module 360 may function to remove security from and within a document, such that modifications and/or additions to the document are possible in instances where such modifications and/or additions are desired.

As an option, the DCE 300 may also be independent from the DCS 200, and may include an interface for performing the document conversion. This may be the case, for example, when the document conversion is performed within a secured network environment by a business entity, which is accessible only to the business entity's employees. For example, the DCE 300 may be provided as a software developer kit (SDK) executed on the business entity's server to convert the business entity's documents as needed and in real-time. In yet a further embodiment, the DCE 300 may be an Application Programming Interface (API), tool, or other stand-alone infrastructure for use in an already existing environment or newly created environment. Where the environment is already in place, i.e., existing, the DCE 300 may include a module for analyzing the existing environment, which may include database structures (external or internal), and communication protocols, which may be used to collect and maintain data from existing documents and incorporating any corresponding DP into any updated or converted documents (e.g., HTML-5).

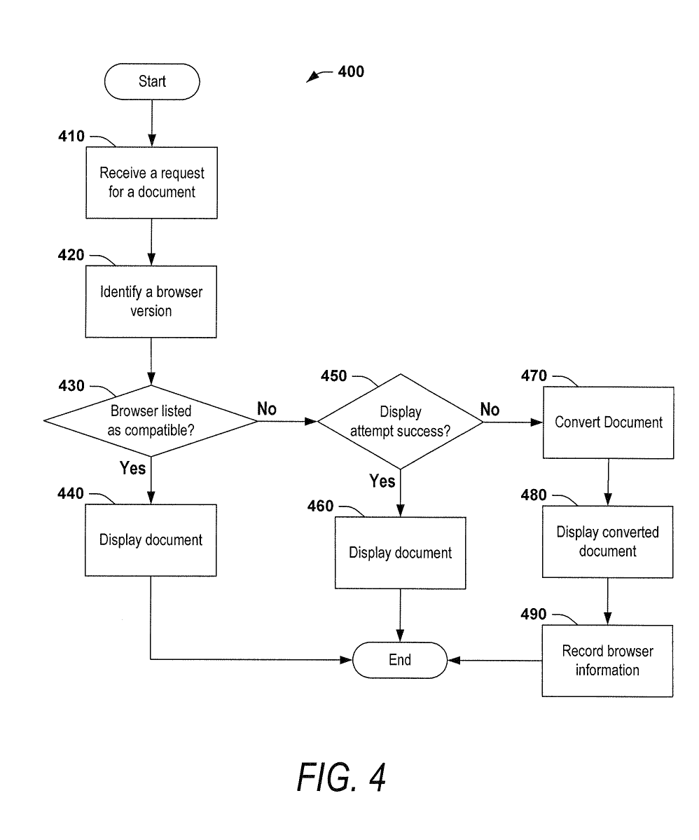

FIG. 4 illustrates an exemplary embodiment of a method 400 of generating a browser compatible document based upon a compatibility database 210 hosted on the DCS 200 of FIG. 2.

In step 410, a request to transmit a document is received by the system 100 via the network 140 from a user. The request may include user information (e.g., locale, login information etc.), in addition to information about the type of device the request is being transmitted from. Also, the request may include information about the type of device or interface employed by the user during his/her request for the document. Each request may come in a single transmission, or a series of transmissions executed simultaneously or individually. For example, an initial request indicates that the user is requesting document number 123.12, which may be a PDF document for a real estate transaction. Thereafter, a second request is transmitted which indicates that the user is using an iPad® device, and that the requesting web browser is Safari® version 1.3. The second request may be made without the user's knowledge. The document, device and browser information may be included in the same request header.

In step 420, the web browser-type is identified by the DCS 200. Using the above example from step 410, in step 420, the Safari® browser would be identified as the browser from which the user is making the request, and as the interface where the requested document will be displayed.

In step 430, the browser information is cross-referenced with a database by the DV module 310 to the DCE 300 to determine whether the browser is listed as being compatible for displaying the requested document. If the browser is listed, in step 440, the requested document is queued and transmitted from the document directory 230, and displayed via the browser. If the browser is not listed as being compatible, then in step 450, the requested document is transmitted to the browser for display. If the requested document is accepted without error during transmission i.e., the transmission was successful, then in step 460, the requested document is displayed to the user in the browser. However, if the transmission from the attempt returns a value identifying that the attempt to display has failed, the DV module 310 flags the requested document as needing converting. In step 470, the document conversion begins via modules 320-360, and the converted document is then displayed in step 480. Alternatively, during the document conversion stage, DS module 360 may be implemented in situations where document security is not requested or required. The converted document may then be recorded to the document directory 230 following a successful conversion, or after the user completes his use of the converted document. In step 490, the browser ID information is then recorded to the database having information browser information. It will be appreciated, that the browser ID information can be recorded to the database upon receiving the browser ID information for later identifying whether or not the browser-type is compatible.

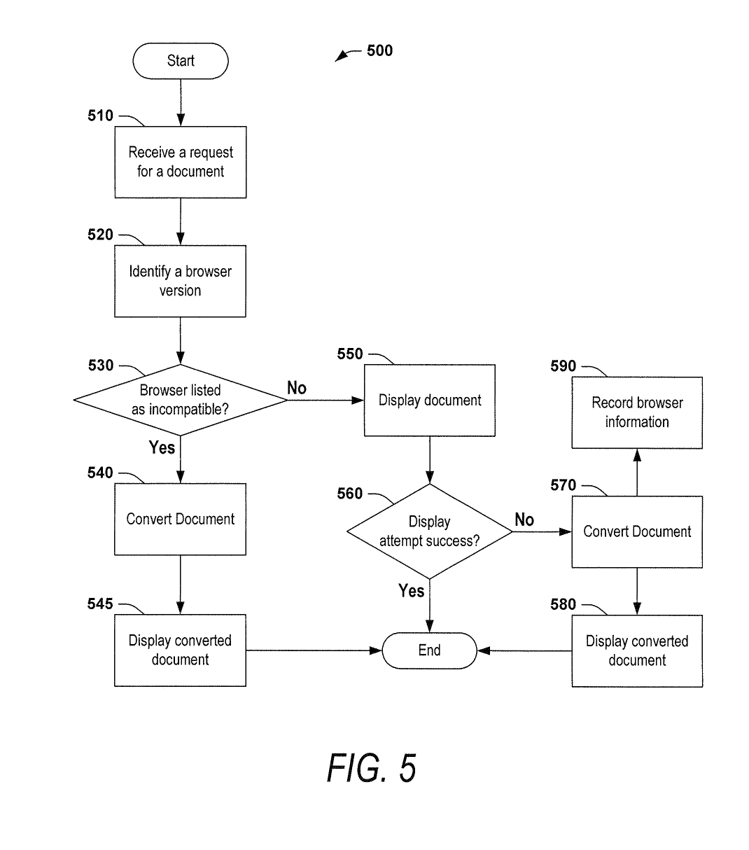

FIG. 5 illustrates an exemplary embodiment of a method 500 of generating a browser compatible document based upon an incompatibility database 210 hosted on the DCS 200 of FIG. 2.

In step 510, a request to transmit a document is received by the system 100 via the network 140 from a user. The request may include user information (e.g., locale, login information etc.), in addition to information about the type of device the request is being transmitted from. Also, the request may include information about the type of device or interface employed by the user during his request for the document. Each request may come in a single transmission, or a series of transmissions executed simultaneously or individually. For example, an initial request indicates that the user is requesting document number 123.12, which may be a PDF document for a real estate transaction. Thereafter, a second request is transmitted which indicates that the user is using an iPad® device, and that the requesting web browser is Safari® version 1.3. The second request may be made without the user's knowledge. As in the previous embodiment, the document, device and browser information may be included in the same request header, or by other suitable locating having document, device, and browser information.

In step 520, the web browser-type is identified by the DCS 200. Using the above example from step 510, in step 520, the Safari® browser would be identified as the browser from which the user is making the request, and as the interface where the requested document will be displayed.

In step 530, the browser information is cross-referenced with a database by the DV module 310 to the DCE 300 to determine whether the browser is listed as being incompatible for displaying the requested document. If the browser is listed, in step 540, the document conversion begins via modules 320-360, and the converted document is then displayed in step 545. The converted document may then be recorded to the document directory 230 following a successful conversion, or after the user completes his use of the converted document. If the browser is not listed as being incompatible, then in step 550, the requested document is transmitted from the document directory 230, and transmitted to the browser for display. If the requested document is accepted without error during transmission i.e., the transmission was successful, then in step 560, the requested document is displayed to the user in the browser. However, if the transmission from the attempt returns a value identifying that the attempt to display has failed, the DV module 310 flags the requested document as needing converting. In step 570, the document conversion begins, and the converted document is then displayed in step 580. Alternatively, during the document conversion stage, DS module 360 may be implemented in situations where document security is not requested or required. As previously stated, the converted document may then be recorded to the document directory 230 following a successful conversion, or after the user completes his use of the converted document. In step 590, the browser ID information is then recorded to the database having information browser information. It will be appreciated, that the browser ID information can be recorded to the database upon receiving the browser ID information for later identifying whether or not the browser-type is compatible.

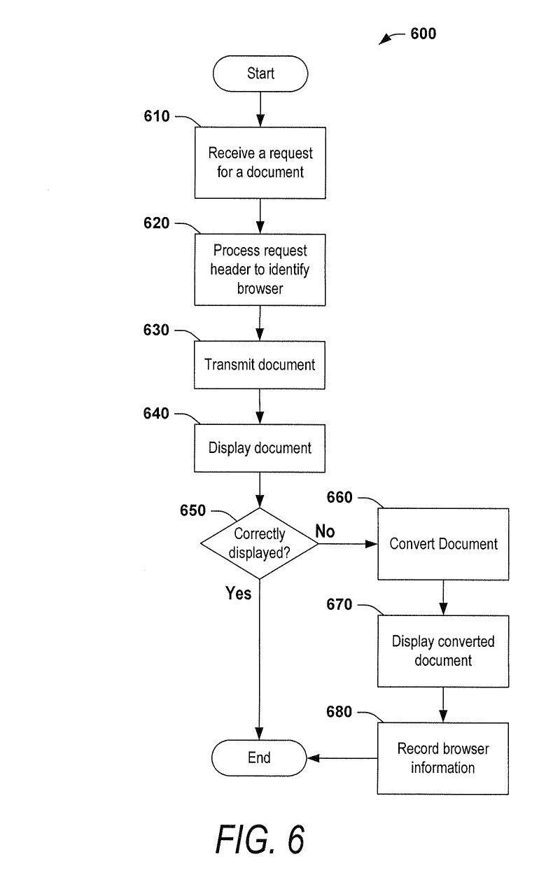

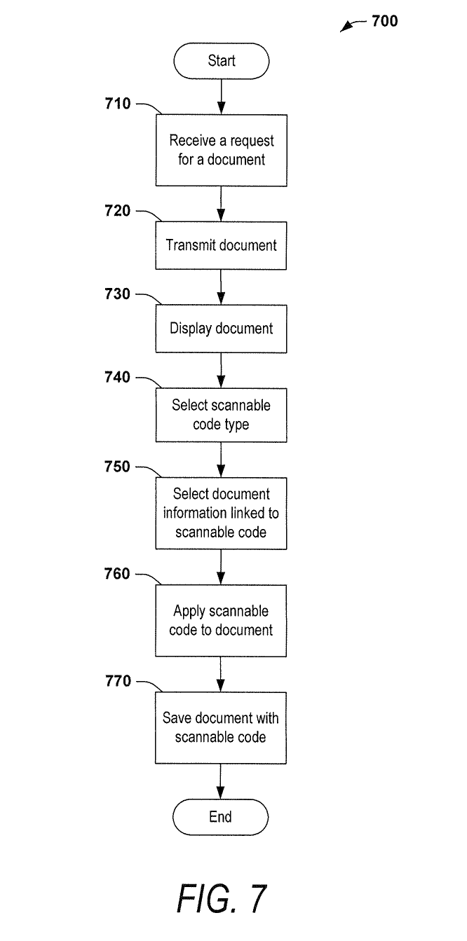

FIG. 6 is a flowchart of an example of an embodiment of a method 600 of converting a browser compatible document based on a display confirmation transmission as implemented in the system 100 of FIG. 1. The method 600 differs from the previous methods in that the method 600 does not require that the browser ID or other information received be cross-referenced with a listing of compatible or incompatible browser-types.

In step 610, a request to transmit a document is received by the system 100 from a user over the network 140. The request may include user information (e.g., locale, login information etc.), in addition to information about the type of device or interface the request is being transmitted from. Each request may come in a single transmission, or a series of transmissions executed simultaneously or individually. For example, an initial request indicates that the user is requesting document number 123.12, which may be a PDF document for a real estate transaction. Thereafter, a second request may be transmitted which indicates that the user is using an iPad® device, and that the requesting web browser is Safari® version 1.3. The second request may be made without the user's knowledge. As in the previous embodiment, the document, device and browser information may be included in the same request header, or by other suitable locating having document, device, and browser information.

In step 620, the document request is processed by the DCS 200 to identify the web browser-type. Using the above example from step 610, in step 620, the Safari® browser is identified, via a request header, as the browser being for which the user is making the request, and as the interface where the requested document will be displayed.

In step 630, the requested document is queued and then transmitted from the document directory 230 over the network 140 to the user for display. In step 640, an attempt to display the requested document via the browser is made. In step 650, depending on the outcome of the attempt in step 640, a confirmation is transmitted within the system 100 identifying whether the requested document was displayed successfully, or whether the attempt to display the document has failed. In the instance where the requested document transmission fails, the DV module 310 flags the requested document as needing converting. In step 660, the document conversion begins via modules 320-360, and the converted document is then displayed in step 670. Alternatively, during the document conversion stage, DS module 360 may be implemented in situations where document security is not requested or required. The converted document may then be recorded to the document directory 230 following a successful conversion, or after the user completes his use of the converted document. In step 680, the browser ID information is then recorded to the database having information browser information. It will be appreciated, that the browser ID information can be recorded to the database upon receiving the browser ID information for later identifying whether or not the browser-type is compatible. It will be appreciated that in the embodiment of method 600, the step of identify the browser-type is not be necessary for determining whether to display the requested document, but instead, may be used for later recording the browser-type should the document conversion be needed.

It should be appreciated that the steps of the method embodiments described herein are for exemplary purposes, and are not required to be performed in a particular sequence. Further, multiple steps may also be combined in to a single step, depending on an individual's needs. For example, step 420 above may be performed in step 410, once the browser information is first received. Also, the step of cross-checking the browser type can also be performed during the step where the browser-type is first identified. Additionally, specific steps may be optional if they are not required, and depending on the whether the steps are desirable. For example, the steps of converting the document may be omitted if all that is desired is to record the browser-type information, or the step of checking the document integrity may be omitted where document integrity is not a concern.

As mentioned above, while exemplary embodiments have been described in connection with various computing devices and network architectures, the underlying concepts may be applied to any network system and any computing device or system in which it is desirable to implement a game for real-world application.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes both computer-readable storage media and communication media including any medium that facilitates transfer of a computer program from one place to another. A computer-readable storage media can be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Also, a connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a communication module configured to receive, from a client device, a request for a document, to transmit a version of the document to the client device in response to the request, and to receive, from the client device, user input related to the version of the document transmitted;
a document engine configured to obtain the version of the document, wherein the version of the document obtained is displayable on a browser of the client device form which the request is received;
a document editing module configured to embed a scannable code to the document in accordance with the user input received; and
a non-transitory, computer-readable storage medium, wherein the document engine and the document editing module comprise computer-executable instructions stored on the non-transitory, computer-readable storage.

2. The system of claim 1, wherein the document editing module is further configured to encode document-related information in the scannable code.

3. The system of claim 2, wherein the document-related information includes a document identifier employable to retrieve the document.

4. The system of claim 3, wherein a scan, by a second client device, of the scannable code embedded in the document generates a second request for the document which is received by the communication module, and
wherein the document engine is further configured to obtain a second version of the document in response to the second request for transmission to the second client device by the communication module, the second version of the document being compatible with and displayable by a browser of the second client device.

5. The system of claim 4, wherein the document engine is further configured to receive information related to the second client device and permit access to the second version of the document in accordance with the information received.

6. The system of claim 2, wherein the document-related information includes at least one of a document creation date, contact information of entities associated with the document, or e-signature information.

7. The system of claim 2, wherein the scannable code is at least one of a QR code, a barcode, or a scannable image. the document editing module obtains the document-related information from the user input.

8. The system of claim 2, wherein the document engine is further configured to update the document-related information in accordance with the user input received.

9. The system of claim 8, wherein the user input received comprises an e-signature applied to the document.

10. The system of claim 1, further comprising a document data store configured to store a plurality of documents, the plurality of documents including original documents and versions generated by the document engine.

11. The system of claim 1, wherein the version of the document is one of a converted version of an original version of the document, or the original version of the document, and
wherein the document engine is further configured to generate the converted version to be displayable by the client device when the original version of the document is not displayable by the client device.

12. The system of claim 11, wherein the communication module is further configured to transmit the original version of the document of the client device and receive a notification regarding displayability of the original version of the document from the client device.

13. The system of claim 12, wherein, when the notification specifies the original version is not displayable by the client device, the document engine is further configured to:
map a structure of the document to identify document elements and a layout of the document elements;
extract document properties from the document related to the document elements; and
generate the converted version using a document format natively displayable by the browser of the client device, wherein the converted version includes an arrangement of structural elements based on the identified document elements and layout and functional elements corresponding to the document properties extracted.

14. The system of claim 11, wherein the document format of the converted version is an hypertext markup language (HTML) format with embedded JavaScript instructions.

15. The system of claim 11, wherein the original version of the document is in a portable document format (PDF).

16. A method, comprising:
receiving a request, from a client device, for a document retained in a document data store;
obtaining the document from the document data store and transmitting the document to the client device;
receiving, from the client device, first input specifying a placement of a scannable code in the document;
receiving, from the client device, second input specifying document-related information to be encoded by the scannable code, the document-related information being retrievable by a scan of the scannable code and displayable by the client device or employable, by the client device to access other data;
storing the document with the scannable code embedded in the document data store.

17. The method of claim 16, further comprising:
identifying a browser on the client device utilized to transmit the request received;
determining whether the browser identified is capable of displaying the document; and
converting the document to a displayable version when the browser is incapable of displaying the document.

18. The method of claim 17, wherein determining whether the browser is capable of displaying the document comprises referencing a list of browser types with known compatibilities to identify compatibility or incompatibility of the browser identified.

19. The method of claim 17, wherein determining whether the browser is capable of displaying the document comprises:
transmitting the document to the client device; and
receiving a notification from the client device indicating success or failure of displaying the document.

20. The method of claim 16, wherein converting the document to the displayable version comprises:
mapping a structure of the document to identify document elements and a layout of the document elements;
extract document properties from the document related to the document elements; and
generate the displayable version using a document format natively displayable by the browser of the client device, wherein the displayable version includes an arrangement of structural elements based on the identified document elements and layout and functional elements corresponding to the document properties extracted.
